(19) United States
(12) Patent Application Publication
(10) Pub. No.: US 2011/0195602 A1
(43) Pub. Date: Aug. 11, 2011

(54) CARD CONNECTOR WITH ADJUSTMENT SECTIONS

(75) Inventors: ZHI-FENG WANG, Kunshan (CN); KUO-CHUN HSU, Tu-Cheng (TW)

(73) Assignee: HON HAI PRECISION INDUSTRY CO., LTD., Tu-Cheng (TW)

(21) Appl. No.: 12/944,752

(22) Filed: Nov. 12, 2010

(30) Foreign Application Priority Data
Feb. 8, 2010 (CN) 201020302591.5

(51) Int. Cl. H01R 13/648

(52) U.S. Cl. 439/607.22

(57) ABSTRACT

A card connector includes an insulative housing having an elongated base and a pair of arms located at opposite sides of the base thereby defining a receiving cavity therebetween. Each arm defines a guiding slot extending along a rear-to-front direction and in communication with the receiving cavity. A plurality of contacts are retained in the base, each having a pin shaped contacting portion projecting into the receiving cavity and a solder portion extending out of the base. A shell device is attached to the insulative housing. Opposite sides of each guiding slot extend inwardly so as to form an adjustment section interconnecting with the base, which can ensure a card to be inserted accurately.

Page 16 of 16

### BACKGROUND OF THE INVENTION

1. Field of the Invention

The present invention relates to a card connector, and more particularly to a card connector with pin shaped contacts.

2. Description of the Related Art

A card connector apparatus is generally used as an expanded recording apparatus of an electronic equipment such as a personal computer or a digital camera. As a storage medium of the card connector apparatus, a PC card or a memory card has come into wide use. This PC card or memory card is installed in the card connector apparatus to write and read necessary information, one of them is configured as an elongated shape with a plurality of through holes at a distal end thereof.

A card connector for receiving said card comprises a base and a pair of side arms disposed at opposite ends of the base thereby defining a mating cavity therebetween. A plurality of pin shaped contacts retained in the base and projecting into the mating cavity. When said card is inserted into the mating cavity, the pin shaped contacts must be in alignment with the through holes, if there is somewhat offset therebetween, the card can not be inserted successfully. Obviously, an improved card connector is highly desired to overcome the aforementioned problem.

### SUMMARY OF THE INVENTION

Accordingly, an object of the present invention is to provide a card connector for ensuring the card to be inserted accurately.

In order to achieve the object set forth, a card connector includes an insulative housing having an elongated base defining a mating face at a front end thereof and a pair of arms extending from opposite sides of the base along a rear-to-front direction thereby defining a receiving cavity therebetween. A pair of guiding slots are respectively defined at an inner face of each arm. A plurality of contacts are respectively retained in the base, each contact having a pin shaped mating portion projecting into the receiving cavity through the mating face and a solder portion extending rearward and downward. A shield device encloses said insulative housing. A pair of adjustment sections extend forward from the mating face and are located adjacent to the guiding slots under condition that each adjustment device has a slantwise guiding face and a horizontal portion which is in alignment with the guiding slot.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of a conventional card;

FIG. 2 is a perspective view of a card connector in accordance with the present invention using said conventional card;

FIG. 3 is another perspective view of the card connector, seen from a bottom side;

FIG. 4 is an exploded perspective view of the card connector shown in FIG. 2;

FIG. 5 is another exploded perspective view of the card connector in FIG. 3;

FIG. 6 is a partly exploded perspective view of the card connector in FIG. 2 with a metallic shell releasing from the card connector;

FIG. 7 is another perspective view of the card connector in FIG. 2;

FIG. 8 is a partly amplified perspective view of the card connector in FIG. 2; and

FIG. 9 is a front view of the card connector in FIG. 2.

### DETAILED DESCRIPTION OF THE INVENTION

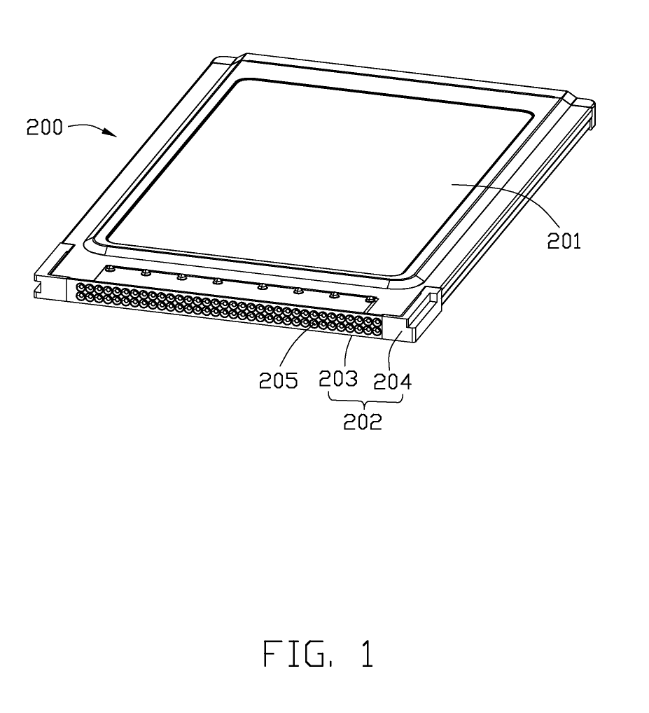

Reference will now be made to the drawing figures to describe a preferred embodiment of the present invention in detail. Referring to FIG. 1, a conventional PC card 200 comprises a rectangular body portion 201 and a mating portion 202 located at one end of the body portion 201. The mating portion 202 comprises a base 203 extending along a transverse direction and a pair of guiders 204 located at opposite sides of the base 203. The base 203 defines a plurality of through holes 205 arranged into two rows and opened rearward. Each through hole 205 forms a contacting component therein connecting with memory modules (not shown) retained in the body portion 201.

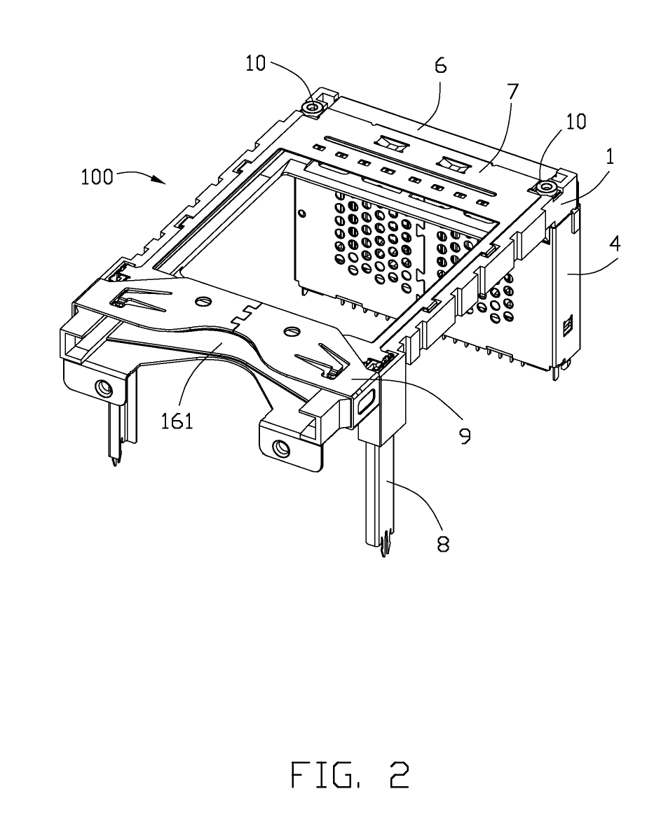

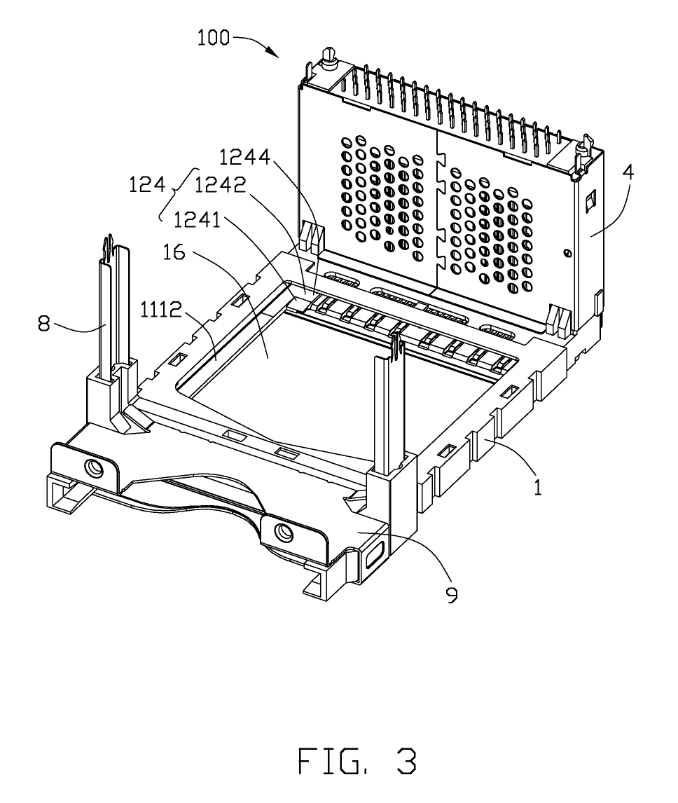

Referring to FIG. 2 to FIG. 5, a card connector 100 made according to the preferred embodiment of the present invention is provided for receiving said conventional PC card 200. The card connector 100 comprises an insulative housing 1, a plurality of contacts 5, a positioning base 2, an auxiliary positioning plate 3 and a shield device. The shield device comprises a metallic shell 4, a grounding plate 6, a metallic cover 7, a pair of supporting tails 8, a retainer 9 and nuts 10.

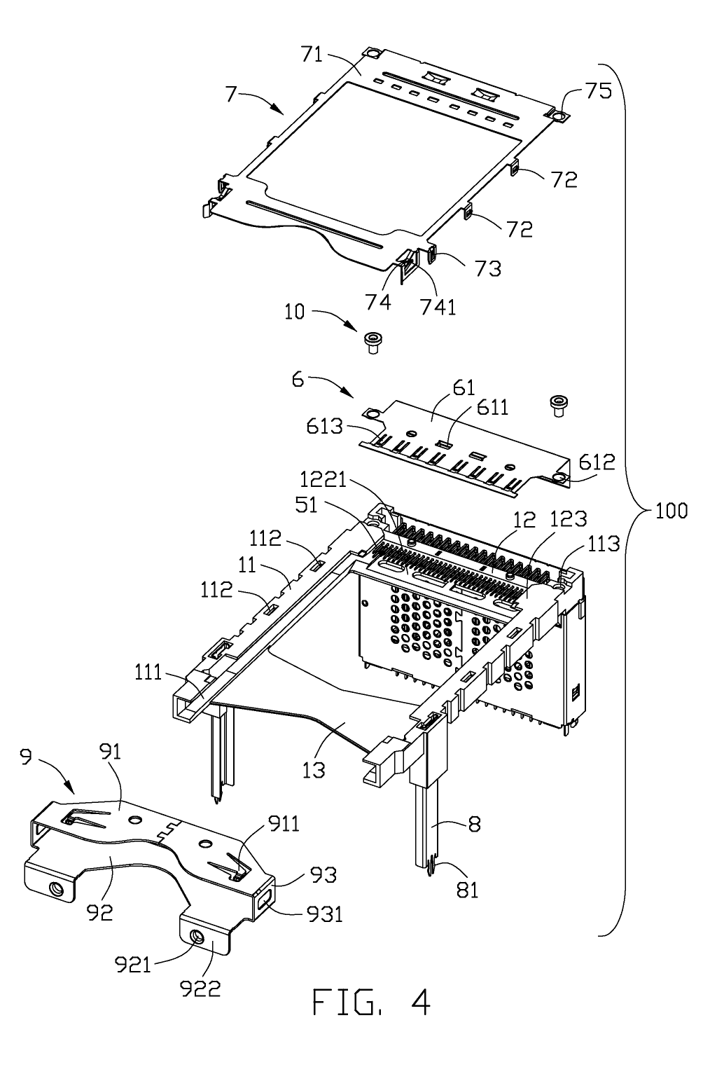

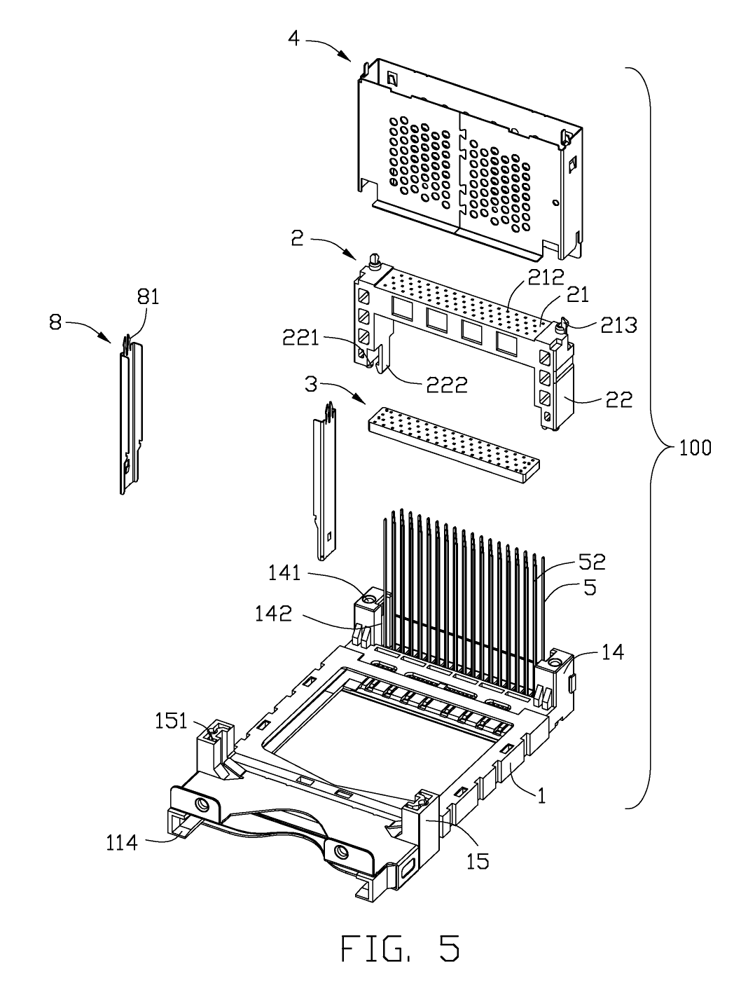

Referring to FIG. 4 to FIG. 5, the insulative housing 1 is in a rectangular configuration having an upper face and a lower face, comprising a base portion 12 extending along the transverse direction and a pair of arms 11 located at opposite sides of the base portion 12 and extending away from the base portion 12 along a rear-to-front direction thereby defining a receiving cavity 16 therebetween. The receiving cavity 16 defines an insertion opening 161 at a front end thereof for allowing the PC card 200 to be inserted thereinto. A pair of guiding slots 111 are defined at inner sides of each arm 11 with a guiding surface 114 at a front end thereof and communicate with the receiving cavity 16. A plurality of holes 112 are defined on an upper face of each arm 11 and communicate with the guiding slot 111. A connecting plate 13 is formed between the pair of arms 11 adjacent to the insertion opening 161 for strengthening the rigidity of the insulative housing 1. A pair of first extending legs 14 extend downward from the lower face of the base portion 12, and a pair of second extending legs 15 extend downward from the lower face of the pair of arms 11. The first and second extending legs 14, 15 are used for increasing the height of the card connector 100 in according to the layout of a printed circuit board. Each first extending leg 14 comprises a through hole 141 opened toward the printed circuit board and a locking portion 142 at a lateral side thereof. Each second extending leg 15 also defines a through hole 151 thereon.

The base portion 12 defines a plurality of receiving grooves thereon and running through a mating face 121 of the base portion 12 along the rear-to-front direction. The contacts 5 are received in the corresponding receiving grooves and each comprises a pin shaped mating portion 51 and a solder portion 52 extending downwardly from the mating portion 51. The pin shaped mating portion 51 projects into the receiving cavity 16 to be inserted into the corresponding through hole 205 on the PC card 200 when the PC card 200 is inserted into the receiving cavity 16 so as to realize a signal transmission. The auxiliary positioning plate 3 is configured as a rectangular shape and defines a plurality of positioning holes 31 therein for receiving said solder portions 52 of the contacts 5, which is helpful for controlling the alignment of the solder portions 52.

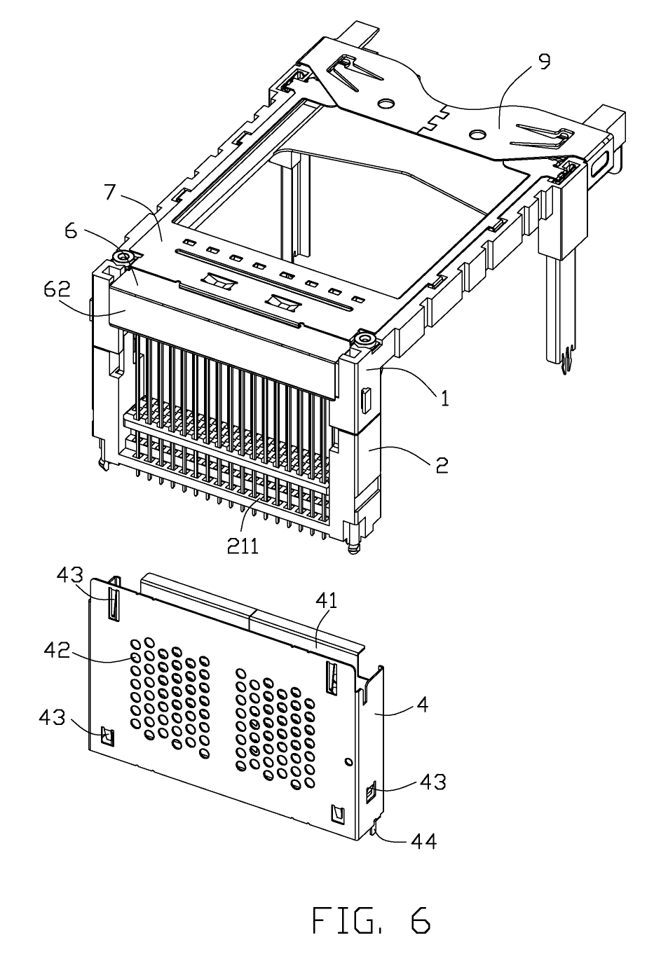

Referring to FIGS. 5 and 6, the card connector 100 is configured as a high profile configuration with the positioning base 2 located at the lower face of the insulative housing 1. The positioning base 2 comprises an elongated body 21 and a pair of supporting arms 22 extending upward from opposite sides of the elongated body 21. The elongated body 21 comprises several steps 211 offset to each other and defines a plurality of through channels 212 thereon for further positioning the solder portions 52 of the contacts 5. A pair of positioning legs 213 is formed at opposite sides of the body 21 for inserting into the printed circuit board together with the solder portions 52. A positioning post 221 and a hook portion 222 are formed at a free end of each supporting arm 22 for cooperating with the through hole 141 and the locking portion 142 of the first extending legs 14 when the positioning base 2 is assembled onto the insulative housing 1.

The metallic shell 4 is configured as an enclosed rectangular shape and defines a receiving room 41 therein for receiving the first extending legs 14 of the insulative housing 1, the positioning base 2 and the auxiliary positioning plate 3 therein, therefore solder portions 52 are enclosed by the metallic shell 4 which is helpful for preventing ESD. A plurality of openings 42 are defined on the metallic shell 4 for heat elimination. A plurality of spring tabs 43 are formed on the metallic shell 4 for maintaining the metallic shell 4 on the positioning base 2 and electrically contacting with the grounding plate 6. Moreover, a pair of tails 44 extend downward from the metallic shell 4 to be retained in the printed circuit board.

Referring to FIGS. 2, 4 and 6, the grounding plate 6 is assembled onto the base portion 12 of the insulative housing 1, and comprises a first plate 61 and a second plate 62 perpendicularly extending downward from a front end of the first plate 61. A plurality of retaining bars 611 are formed on the first plate 61 for securing the grounding plate 6 on the base 12 of the insulative housing 1. A pair of ears 612 are formed on lateral sides of the first plate 61, each defines a hole thereon. A plurality of resilient plates 613 are stamped downwardly toward the receiving cavity 16 for increasing the interference between the PC card 200 and the card connector 100. The second plate 62 is electrically contacting with the metallic shell 4 for establishing a grounding path.

Referring to FIGS. 2, 4 and 5, the supporting tails 8 are inserted into the through holes 151 on the second extending legs 15, while the other end of each supporting tail 8 forms a grounding tail 81 inserted into the printed circuit board. The metallic cover 7 is located at the upper face of insulative housing 1 and comprises a rectangular body 71 covering the upper face of the insulative housing 1. A plurality of locking plates 72 and connecting plates 73 extending downward from lateral edges of the body 71 for respectively inserting into the holes 112 on each arm 11 and through holes 151 on the second extending legs 15. The connecting plates 73 are electrically contacting with the supporting tails 8 for establishing the grounding path. A pair of grounding pads 74 are located at opposite sides of the front end of the metallic cover 7 and attached to the arm 11. Each grounding pad 74 has a resilient plate 741 projecting into the guiding slot 111. A pair of ears 75 are located at opposite sides of the front end of the metallic cover 7 and stacked with the ears 612 of the grounding plate 6 to align with screws 113 which are defined on each arm 11 adjacent to the base portion 12. The nuts 10 are inserted into the screws 113 by passing through the ears 75, 612 so as to combine the metallic cover 7, the grounding plate 6 and the insulative housing 1 together.

Referring to FIGS. 2 and 4, the retainer 9 is assembled onto the insulative housing 1 finally and enclosing the front end of the insulative housing 1 and the metallic cover 7. The retainer 9 is configured as a frame shape and comprises an upper wall 91, a lower wall 92 and a pair of side walls 93. Each side wall 93 defines a rib 931 protruding inwardly to abut against the arm 11. A pair of resilient plates 911 protrude inwardly from the upper wall 91 and engage with metallic cover 7 electrically. A pair of flanges 922 extend forward from the lower wall 92 and bend downwardly to align with the front end of the arms 11. Each flange defines a retaining hole 921 therein for connecting the card connector 100 with an exterior electronic device (not shown). When the PC card 200 is inserted into the card connector 100, the resilient plate 741 of the metallic cover 7 and the resilient plates 613 of the grounding plate 6 contact with a periphery of the PC card 200 so as to realize grounding connection.

The grounding plate 6 contacts with the rear end of the PC card 200 and realizes grounding connection through the metallic shell 4, while the metallic cover 7 contacts with the front end of the PC card 200 and realizes grounding connection through the nuts 10 which connects with the grounding plate 6 and the metallic cover 7. Moreover, the first extending legs 14 are assembled onto the positioning base 2 and the second extending legs 15 are supported by the supporting tails 8, which makes the card connector 100 a high profile and defines a large space under the card connector 100 for positioning other components.

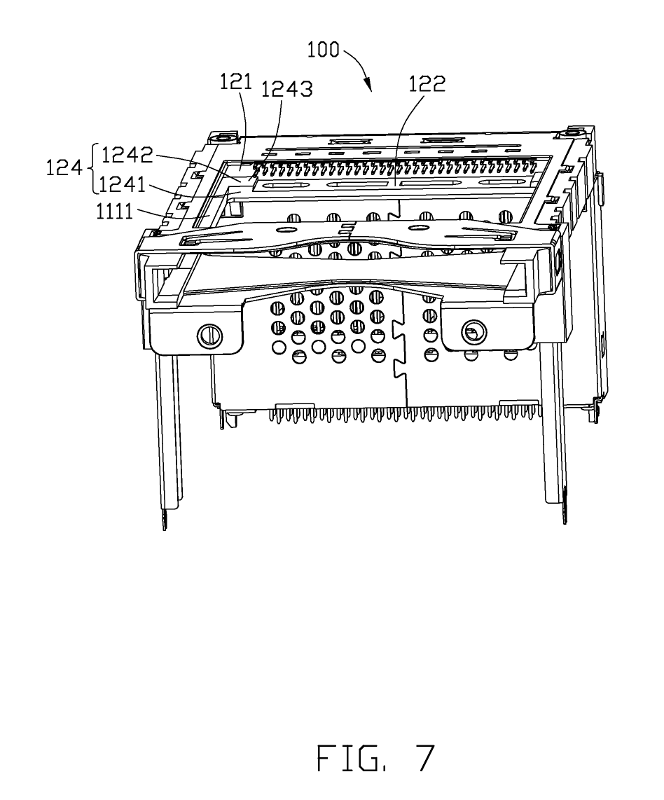

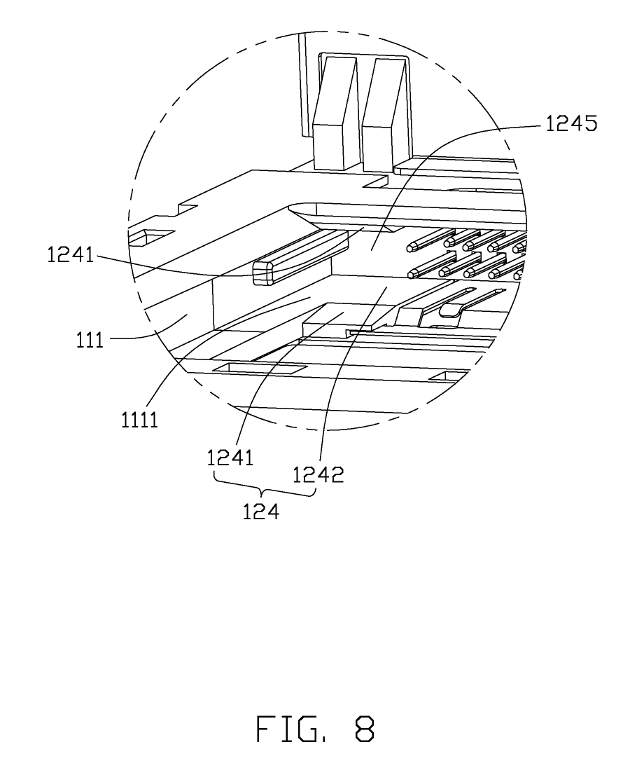

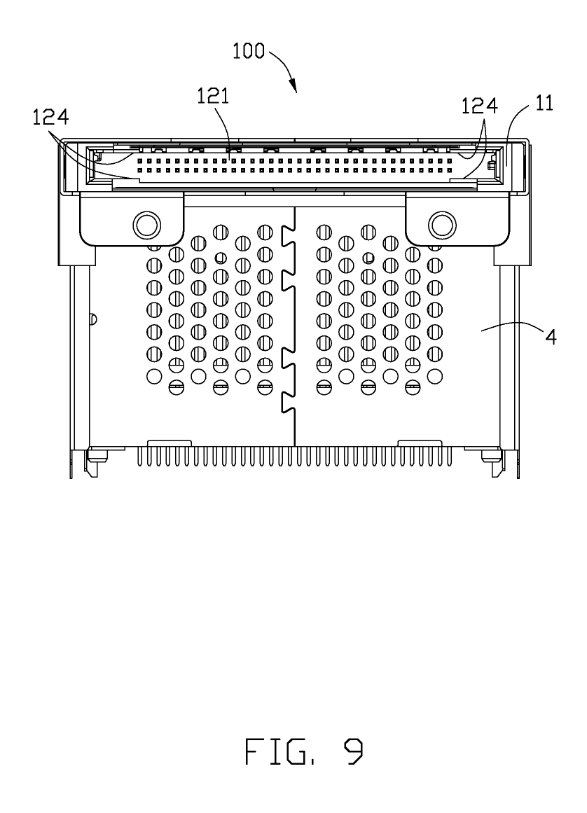

Referring to FIGS. 1, 3, 4, 7, 8 and 9, the pin shaped mating portions 51 project into the receiving cavity 16 by running through the mating face 121 of the base portion 12. A connecting plate 122 is located at a lower side of the mating face 121 and lower than a bottom face 1111 of the guiding slot 111. The connecting plate 122 is perpendicular to the mating face 121 and sandwiched between the pair of arms 11. A pair of extending walls 123 are formed at each joint of a top face 1112 of the guiding slot 111 and the connecting plate 122. The distance between the top face 1112 and the bottom face 1111 of the guiding slot 111 is equal to the thickness of each guider 204 of the PC card 200, and the width of the guiding slot 111 is equal to the width of the guider 204. A pair of adjustment sections 124 are formed on the connecting plate 122 and the extending wall 123 and located beside the guiding slot 111 and adjacent to the mating portions 51. The adjustment section 124 has a slantwise guiding face 1241 and a horizontal adjustment portion 1242 connecting the guiding face 1241 and the mating face 121. The horizontal adjustment portion 1242 has an upper adjustment portion 1243, a lower adjustment portion 1244 and an adjustment space 1245 therebetween. The lower adjustment portion 1244 is coplanar with the bottom face 1111 of the guiding slot 111. The outmost mating portions 51 are disposed in the adjustment space 1245.

The PC card 200 is inserted into the receiving cavity 16 by the guiders 204 sliding along the guiding slots 111 until the mating portion 202 reaching to the guiding face 1241 of the adjustment section 124. With the further movement, the mating portion 202 will enter into the adjustment space 1245 and joints of the base 203 and the guider 204 will be sandwiched by the upper adjustment portion 1243 and the lower adjustment portion 1244. Under this condition, even there is little deflection between the base 203 and the guider 204, the adjustment section 124 will adjust the deflection and ensure the mating portions 51 to be inserted into the through holes 205 of the PC card 200 accurately.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A card connector comprising:
an insulative housing having an elongated base defining a mating face at a front end thereof and a pair of arms extending from opposite sides of the base along a rear-to-front direction thereby defining a receiving cavity therebetween, a pair of guiding slots being respectively defined at an inner face of each arm;
a plurality of contacts respectively retained in the base, each contact having a pin shaped mating portion projecting into the receiving cavity through the mating face and a solder portion extending rearward and downward; and
a shield device, enclosing said insulative housing; wherein
a pair of adjustment sections extend forward from the mating face and are located adjacent to the guiding slots under condition that each adjustment device has a slantwise guiding face and a horizontal portion which is in alignment with the guiding slot.

2. The card connector as described in claim 1, wherein a connecting plate connected with the arms is located in front of the base and lower than the guiding slots in a vertical direction perpendicular to the rear-to-front direction, said adjustment sections stands on the connecting plate.

3. The card connector as described in claim 2, wherein the adjustment sections are located at joints of the base and the arms.

4. The card connector as described in claim 3, wherein a grounding plate is located opposite to the connecting plate.

5. The card connector as described in claim 1, wherein a pair of first and second extending legs are respectively formed at four corners of a bottom face of the insulative housing thereby making the card connector into a high profile.

6. The card connector as described in claim 5, wherein the shield device comprises a metallic shell enclosing the solder portions of the contacts, a grounding plate and a metallic cover covering the insulative housing and stacked together by a pair of nuts which are electrically contacting with the metallic shell.

7. The card connector as described in claim 6, wherein a frame shaped retainer is assembled on a front end of the arms and defines an opening for allowing a card to be inserted thereinto.

8. A card connector comprising:
an insulative housing having an elongated base and a pair of arms located at opposite sides of the base thereby defining a receiving cavity therebetween, each arm defining a guiding slot extending along a rear-to-front direction and in communication with the receiving cavity;
a plurality of contacts retained in the base, each having a pin shaped contacting portion projecting into the receiving cavity and a solder portion extending out of the base; and
a shell device attached to the insulative housing; wherein opposite sides of each guiding slot extend inwardly so as to form an adjustment section interconnecting with the base.

9. The card connector as described in claim 8, wherein the adjustment section defines an adjustment space therein which is in alignment with the guiding slot.

10. The card connector as described in claim 9, wherein the outmost contacting portions are located in the adjustment space.

11. The card connector as described in claim 8, wherein a pair of first extending legs and second extending legs are disposed under a bottom face of the insulating housing thereby defining a receiving room under the bottom face for receiving other components.

12. An electrical card connector comprising:
an insulative housing including an elongated base extending in a transverse direction and a pair of side arms extending at two opposite ends of said base in a front-to-back direction perpendicular to said transverse direction;
a card receiving space defined among said base and said pair of side arms;
a plurality of pin type contacts retained in the base and having a mating section located in front of the base and extending into the card receiving space, and a tail section located behind the base;
the base unitarily defining two pairs of guiding surfaces by two opposite sides of said contacts in a vertical direction perpendicular to both said transverse direction and said front-to-back direction, and proximate said pair of side arms, respectively;
a rear supporting device supportably located below the base for electrical connection of the contacts to a printed circuit board on which the connector is mounted; and
a front supporting device supportably located below a front section of each of said side arms; wherein
said front supporting device includes an upper section unitarily formed with the corresponding side arm, and a lower section being a metallic piece retained to the upper section and extending downward with a structure for mounting to said printed circuit board.

13. The electrical card connector as claimed in claim 12, wherein said housing further includes a connecting plate linked between said pair of side arms beside the card receiving space in the vertical direction.

14. The electrical card connector as claimed in claim 12, further including a metallic retainer attached to the front sections of the side arms and surrounding an insertion opening of the card receiving space.

15. The electrical card connector as claimed in claim 14, wherein said housing further includes a connecting plate linked between said pair of side arms beside the card receiving space in the vertical direction.

16. The electrical card connector as claimed in claim 15, wherein said connecting plate is enclosed by said retainer.
